(19) United States
(12) Patent Application Publication
(10) Pub. No.: US 2008/0316605 A1
(43) Pub. Date: Dec. 25, 2008

(54) Spectacles With Embedded Segmented Display Comprising Light Guide End

(75) Inventors: Michael S. Hazell, Cambridge (GB); Nicola Millar, Cambridge (GB); Roger F. Golder, Cambridge (GB); Paul Williamson, Cambridge (GB)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Cambridge Consultants Limited, Cambridge (GB)

(21) Appl. No.: 11/913,767

(22) PCT Filed: May 5, 2006
(86) PCT No.: PCT/GB06/01653

§ 371 Date: Jun. 27, 2008

(30) Foreign Application Priority Data
May 6, 2005 (GB) 0509308.3

(51) Int. Cl. G02B 27/01; G02C 7/00

(52) U.S. Cl. 359/630; 351/158

(57) ABSTRACT

An optical device, such as spectacles or goggles, has a segmented display (3) formed in a transparent substrate by directing light from a number of light sources (15) through respective light guides (14) and reflecting the light out of the transparent substrate at the ends of the light guides (14) to form individually illuminable segments (13). The device has the advantage that an electronically-generated display can be displayed to a viewer in combination with the image transmitted through the transparent substrate simply and relatively inexpensively.

### FIELD OF THE INVENTION

The present invention relates to an optical device, in particular to an optical device for displaying information in the field of vision of a viewer. The invention is of particular application to head-mounted imaging devices, such as eyeglasses, goggles, or masks, in which information is incorporated into the image viewed by the wearer by a display device.

### BACKGROUND OF THE INVENTION

Systems are known for combining an electronically-generated display with the image viewed by the wearer of eyeglasses or goggles. Such systems fall into three main areas: ‘see through’ displays, in which the displayed image is combined with the background image; ‘see around’ displays, in which the displayed image blocks some of the background image; and ‘fully blocking’ displays, in which none of the background image is visible. Existing designs are often bulky and heavy and most have optical components that protrude from the eyewear lens, obscure part of the user's vision and are susceptible to damage.

From a user-acceptance perspective, the most desirable solution is the ‘see through’ display. For example, U.S. Pat. No. 5,886,822 describes an optical system that combines a first image formed by a main lens with a second image provided by an electronic display mounted at the edge of the main lens. The system forms an image of the electronic display in the user's field of view using refractive optics embedded in the main lens. However, this system has the disadvantage that the refractive optics must be constructed very accurately in order that the image presented to the user is not distorted and the user can read the display. The required accuracy of the optics can lead to the thickness of the main lens becoming unacceptably large.

It would be desirable to produce lightweight spectacles or goggles which incorporate an electronically-generated display in the user's field of view, but that do not require coherent imaging optics to be used.

### SUMMARY OF THE INVENTION

The present invention provides an optical device comprising a transparent substrate having a periphery and a plurality of optical guides, each having at least one terminal portion. Each optical guide is arranged to guide light from the periphery of the substrate to the terminal portion of the optical guide and each terminal portion is configured to direct light, in use, from the optical guide outwardly from the transparent substrate towards a viewer. The terminal portions are arranged to form a segmented display, such that selective illumination of the terminal portions in combination displays information to the viewer.

Thus, according to the invention, optical guides transmit light from the edge of the transparent substrate, for example a spectacle lens, to their terminal portions which form a segmented display that the viewer can read in combination with the image transmitted by the substrate. In the device of the invention, it is unnecessary for the optical guides to transmit a coherent image, because the display is formed by the arrangement of the terminal portions, when illuminated. Consequently, the optical guides can be formed without the optical imaging requirements of the prior art. Moreover, the optical guides can be made of material that is effectively transparent to the viewer so that there is practically no obstruction of the field of view defined by the transparent substrate. The reduced accuracy requirements and relatively large field of view mean that the optical device can be manufactured with relatively low cost and size.

The transparent substrate may be in the form of a lens or window for spectacles, goggles or the like. The substrate may be flat, curved, lenticular or any other suitable shape. Conveniently, the substrate is substantially planar. The transparent substrate may be formed from a single layer to which the optical guides are applied, for example mounted or bonded. Alternatively, the optical guides may be sandwiched between multiple layers of the transparent substrate. In either case, the optical guides may be formed, for example moulded, within the transparent substrate.

The optical guides may be located on a surface of the transparent substrate. Preferably, however, the optical guides are located within the transparent substrate. In this way the optical guides are protected from dirt and damage. The optical guides may be formed integrally with the transparent substrate. In the presently preferred embodiment, the transparent substrate comprises at least two layers between which the optical guides are located. Such an embodiment is particularly convenient to manufacture.

The optical device may comprise a lens arranged to produce a focussed image of the segmented display for the viewer, in use. For example, the image of the segmented display may be focussed substantially at infinity. In this way, the viewer is able to view the display in the same focus as distant objects and the apparent size of the display to the user may be much larger than the actual space occupied by the display on the transparent substrate.

The terminal portion of each optical guide comprises a reflecting surface at an acute angle, for example substantially 45°, to the direction of light transmission within the optical guide, the surface being arranged to reflect the light from the optical guide towards the viewer. Thus, the optical guide may be terminated in a reflecting surface arranged to bend the light substantially through a right angle. However, the particular angle is not significant. The ends of the optical guides may take the form of prisms, therefore.

In the presently preferred embodiments, the terminal portion of each optical guide comprises a plurality of the reflecting surfaces. In this way, light can be reflected from the terminal portions of the optical guides over a larger apparent spatial area, giving larger segments from a single optical guide. Thus, the terminal portion of at least some of the optical guides may fork into a plurality of light paths, each having a respective reflecting surface. In this case, the terminal portion of the optical guide diverges into a plurality of optical guides which may cover a wider apparent space than the unforked guide. Similarly, the terminal portion of at least some of the optical guides may have a stepped profiled, with each step having a respective reflective surface. In this case, the profile of the terminal portion comprises sections of decreasing thickness each terminated by a reflecting surface, so that a portion of the light from the optical guide is reflected out towards the viewer at each surface.

The optical device may comprise a respective light source for each optical guide. In this way the segments of the segmented display may be illuminated by activating the respective light source. Alternatively, a single light source may be used with appropriate switching or shuttering to selectively illuminate a plurality of optical guides.

Conveniently, the light sources may be mounted to the periphery of the transparent substrate, as this minimises the length of the light paths to the segments. The light sources may interface with the optical guides at a surface of the optical guide that is substantially perpendicular to the longitudinal direction of the optical guide. Alternatively, the optical guide may be provided with a reflecting surface at its end proximate the light source to reflect light from the light source into the optical guide. This has the advantage that the light source may be mounted in the plane of the surface of the transparent substrate.

The segmented display may be a numeric or alphanumeric display, such as a seven, fourteen or sixteen segment display. However, other configurations are possible and it is only necessary for the display to communicate information to the viewer by the selective activation of the segments. For example, the segmented display may represent non-alphanumeric characters or icons. Alternatively or in addition, the segmented display may represent a bar graph or similar indicator.

The invention extends to eyewear comprising an optical device according to the invention. The eyewear may be spectacles, goggles, helmets, masks. The goggles may be intended for swimming, diving, skiing, flying, etc. It is a particular advantage of the invention that the optical device is very easily made waterproof. Applications for this technology are envisaged for eyewear in many areas e.g. sports (including under-water sports), security and safety, emergency services, military, medical, fashion, entertainment etc. Examples of non-eyewear applications could include viewing lens on cameras, camcorders etc. vehicle windscreens or other optical and scientific instruments.

One application area for this invention is to display information to a wearer of head-mounted eyewear in a convenient head-up display that does not distract the user from the activity that they are engaged in. For example, in sports sunglasses or swimming goggles, the display of real or elapsed time or heart rate, distance traveled, etc.

### BRIEF DESCRIPTION OF THE DRAWINGS

An embodiment of the invention will now be described, by way of example only, with reference to the accompanying drawings, in which:

FIG. 1 shows an embodiment of an optical device according to the invention;

FIG. 2 shows a cross-section through the optical device of FIG. 1;

FIG. 3 shows an exploded cross-section through the optical device of FIG. 1;

FIG. 4 shows the detail of the arrangement of the display in the optical device of FIG. 1;

FIG. 5 shows further detail of the arrangement of the display in the optical device of FIG. 1;

FIG. 6 shows in cross-section further detail of the arrangement of the display in the optical device of FIG. 1; and

FIG. 7 is a schematic representation of the control system for the optical device of FIG. 1.

### DESCRIPTION OF EMBODIMENTS OF THE INVENTION

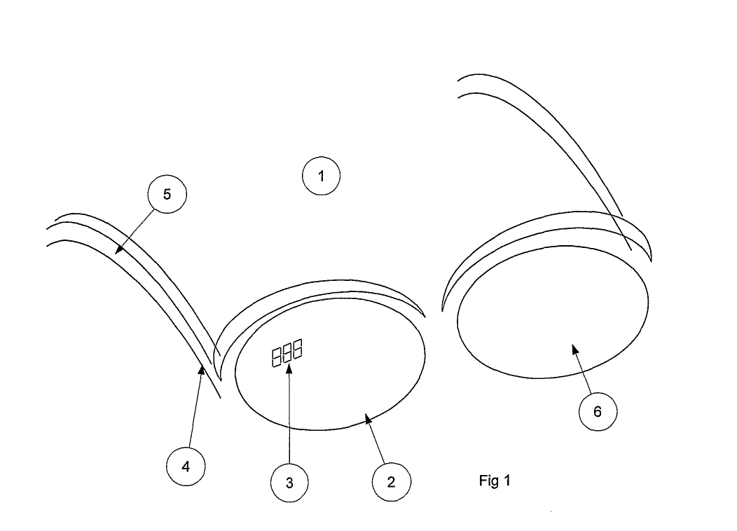

FIG. 1 shows one embodiment of the optical device 2 according to the invention incorporated into spectacles 1. The spectacles 1 comprise the optical device in the form of a compound eyeglass window 2, as well as a conventional eyeglass window 6. The windows 2, 6 are mounted in spectacle support frames 4. The thickness of the compound eyeglass window may be less than 1 mm. Additionally, the windows 2, 6 may be curved to provide an aesthetically pleasing design. The optical device of the invention may be used with normal corrective eyesight lenses or with clip-on lenses, for example, if eyesight correction is required.

A segmented display 3 is provided in the compound eyeglass window 2 and comprises three, seven segment alphanumeric characters, in the embodiment shown. The characters of the display may range in height from 0.1-1 mm and are typically 0.5 mm in height. The total width of the three characters may range from 0.5-3 mm and are typically 1.4 mm in total width. A battery and main electronics 5 are mounted in the arm of the support frame 4 to improve the overall balance of the spectacles for the user.

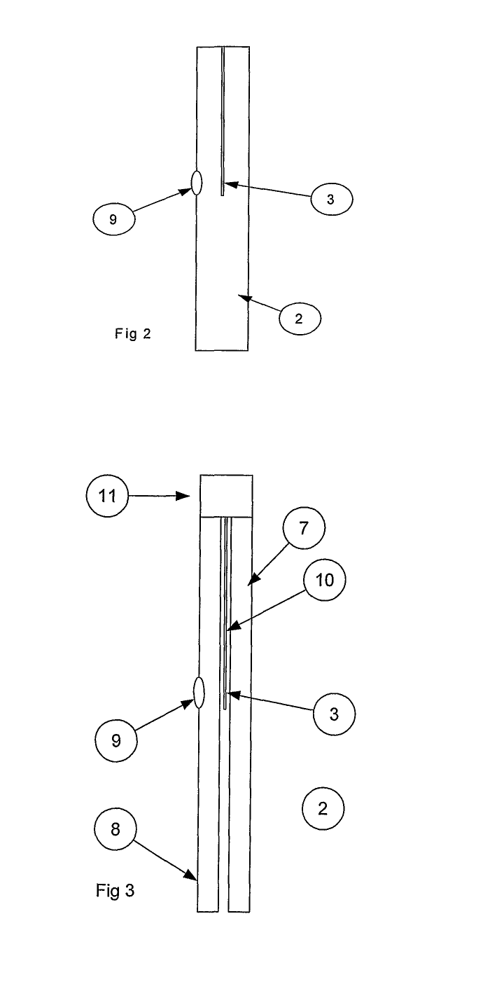

FIG. 2 shows, in cross-section, the location of the optical components that create the segmented display 3 integrated in a thin clear optical window 2 that protects the components from dirt and scratches. The optical window 2 can be flat or curved, as required. Furthermore, the optical window 2 may include, or be formed from, conventional eyesight correction lenses, not shown. Mounted between the user's eye and the compound eyeglass window 2 is a focusing window arrangement 9. This may be a simple lens, lens array, spherical lens or other device that focuses the display 3 as a virtual image at infinity.

FIG. 3 is a cross-section through the compound display window 2 showing the details of the segmented display 3, optical guides 10, protective layers 7, 8, the display image focusing window 9 and the location of light sources 11. As shown in FIG. 3, transparent optical guides 10 are sandwiched between two transparent protective layers 7, 8 of optical quality material, such as polycarbonate. These layers are the eye-side layer 8 and the external layer 7. The protective layers 7, 8 may be formed as an integral unit around the optical guides 10, as a solid material with a spray applied coating, or as two distinct solid elements, for example.

The focusing lens 9 is incorporated into the eye-side layer 8. The focusing lens may be formed separately from the eye-side layer and mounted thereto. Alternatively, the focusing lens 9 may be formed as part of the eye-side layer 8. The optical guides 10 may be formed, for example, as embossed light guides, fibre optics, or by known techniques using different refracting materials. A light source assembly 11 is mounted within or on the edge of the compound eyeglass window 2.

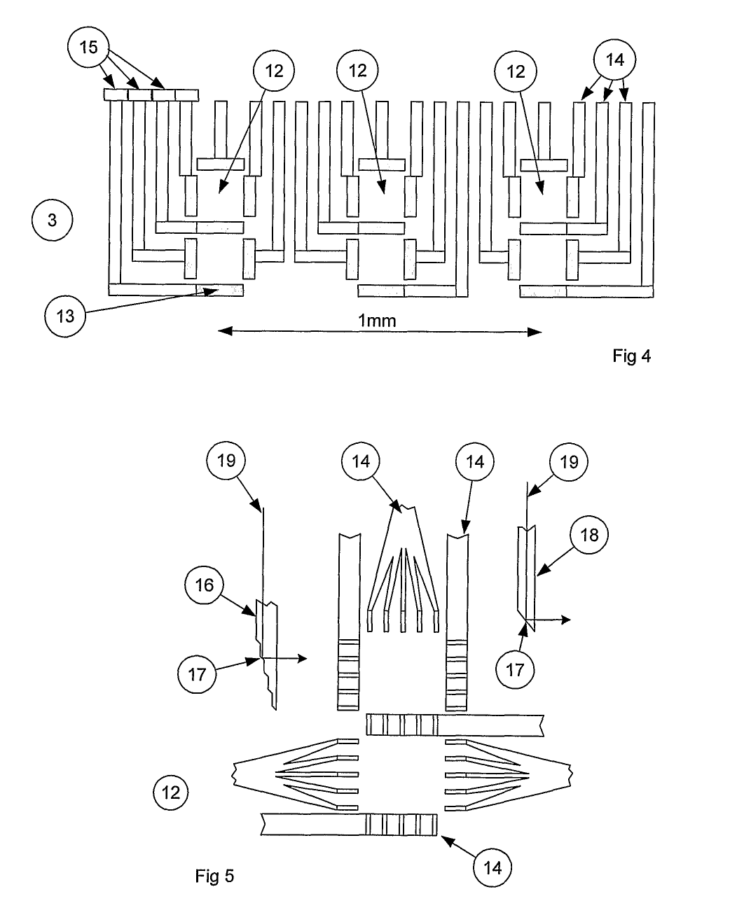

FIG. 4 shows one arrangement of the optical light guides 10 to create a segmented display 3 for displaying alphanumeric characters. The individual light guides 14 can be created in a single plane in a number of different ways, for example by cutting or moulding a channel into the optical window layer 7 or 8 and then filling the trough with a material of higher refractive index than the window material. Another method is a two shot moulding, with each of the moulding shots using optically clear plastic of differing refractive indexes. A third method is to sandwich polymer waveguides 14 between the two protective layers 7, 8.

In a variation of this embodiment, the compound eyeglass window takes the form of a protective base layer 8, for example of polycarbonate that has troughs which are filled with higher refractive index material to create the light guides 14. The entire surface of the protective layer 8 is then coated with a much thinner layer 7 of protective optically clear material of similar refractive index to the base layer 8. The thinner layer 7 may be applied by dipping, or spraying, for example.

The light source 11 is an array made up of individual light emitting sources 15. The light sources may be light emitting diodes (LEDs), organic light emitting diodes (OLEDs), polymer light emitting diodes (PLEDs) or low power laser diodes, for example. A specific example may be a Vertical Cavity Surface Emitting Laser (VCSEL). The light emitting sources 15 may be mounted, printed or moulded onto or into the edge of the compound eyeglass window 2. The light emitting sources 15 interface into individual light guides 14 embedded within the compound eyeglass window 2. In order to maximise the optical power transferred from the light source 15 into the light guide 14 a coherent source such as a laser is ideal. However, because of a perceived health risk from lasers it may be desirable to use a non-coherent light source such as an OLED or LED. The proximity of the light source 15 to the light guide 14 and their relative sizes influences the efficiency of the optical coupling between them. Thus, it is desirable that the areas of the light source 15 and the light guide 14 are matched to ensure maximum optical power transfer.

Each light guide 14 is terminated in such a way that it creates an individual bar or pixel 13 of the alphanumeric segmented display 3. The light sources 15 may be formed as a one or more light emitting sources per light guide 14. The colour of the light sources 15 is not of primary importance but it is advantageous to chose a colour to which the eye is optimally receptive and is distinctive against the background associated with the majority of the user's activities.

The light sources 15 at the top of each light guide 14 are controlled by a simple microcontroller with a serial data link to the main electronics and battery mounted further back on the frame 4 to distribute the weight more evenly for the user. Alternatively, all the electronics may be mounted on the compound eyeglass window 2 with only the battery mounted on the arm of the frame 4. The main electronics may have a variety of functions and may be arranged to receive radio frequency data, for example from a heart-rate sensor mounted in a chest-band. The main electronics and power source are integrated within the eyewear frames 4 and may be implemented using microcontrollers or ASICs. Adjustments of the luminance of the display for different ambient light conditions may also be provided by discrete or ASIC implementations.

The character produced by the segmented display is generated by selectively activating the light sources 15 associated with the required segments 13 of the display 3. The light emitting sources 14 have some simple controlling electronics attached to them to convert the simple serial interface into the commands to turn selected light sources 14 on or off. By incorporating the drive control onto the compound eyeglass window 2 it is only necessary to provide a three-wire interface to the main electronics, as shown in FIG. 7.

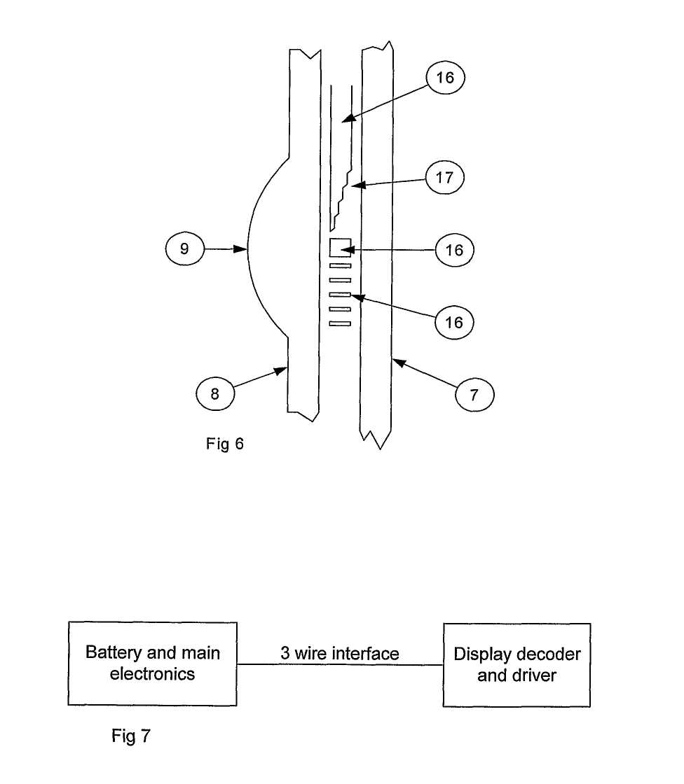

FIGS. 5 and 6 show (in both side and front elevation) two ways in which the end of the light guide 14 can be terminated in such a way that the light ray 19 through the light guide is redirected towards the wearer's eye. The side elevation of the light guide 16 shows one approach in which the light guide is terminated in a stepped reflective surface 17 that creates a series of bright spots by internal reflection. The stepped configuration provides a greater apparent spatial coverage of the segment 13 for a single optical guide 14, because the individual reflected spots from each step of the reflected surface are sufficiently close to give the impression to the viewer of a continuous bar of light.

Another approach is to fan the end of light guide 14 into several terminations, as shown in FIG. 5. The side elevation of the light guide 18 shows a single reflective surface 17 at the tip of each piece of the fan reflecting the light ray 19 to the eye. Again, the fanning out of the end of the light guide 14 gives the impression of greater spatial coverage. Other techniques for redirecting the light ray 19 to the eye may include incorporating a grating or prism at the end of the light guide 14.

In summary, an optical device, such as spectacles or goggles, has a segmented display formed in a transparent substrate by directing light from a number of light sources through respective light guides and reflecting the light out of the transparent substrate at the ends of the light guides to form individually illuminable segments. The device has the advantage that an electronically-generated display can be displayed to a viewer in combination with the image transmitted through the transparent substrate simply and relatively inexpensively.

1. An optical device comprising:
a transparent substrate having a periphery; and
a plurality of optical guides, each having at least one terminal portion,
wherein each optical guide is arranged to guide light from the periphery of the substrate to the terminal portion of the optical guide,
wherein each terminal portion is configured to direct light, in use, from the optical guide outwardly from the transparent substrate towards a viewer, and
wherein the terminal portions are arranged to form a segmented display, such that selective illumination of the terminal portions in combination displays information to the viewer.

2. An optical device as claimed in claim 1, further comprising a lens arranged to produce a focussed image of the segmented display for the viewer, in use.

3. An optical device as claimed in claim 2, wherein the image is focussed substantially at infinity.

4. An optical device as claimed in claim 1, wherein the optical guides are located within the transparent substrate.

5. An optical device as claimed in claim 4, wherein the transparent substrate comprises at least two layers between which the optical guides are located.

6. An optical device as claimed in claim 1 wherein the terminal portion of each optical guide comprises a reflecting surface at an acute angle to the direction of light transmission within the optical guide, the surface being arranged to reflect the light from the optical guide towards the viewer.

7. An optical device as claimed in claim 6, wherein the terminal portion of each optical guide comprises a plurality of the reflecting surfaces.

8. An optical device as claimed in claim 7, wherein the terminal portion of at least some of the optical guides forks into a plurality of light paths, each having a respective reflecting surface.

9. An optical device as claimed in claim 7, wherein the terminal portion of at least some of the optical guides has a stepped profiled, with each step having a respective reflective surface.

10. An optical device as claimed in claim 1, further comprising a respective light source for each optical guide mounted to the periphery of the transparent substrate.

11-12. (canceled)

13. Eyewear comprising:
a transparent substrate having a periphery; and
a plurality of optical guides, each having at least one terminal portion,
wherein each optical guide is arranged to guide light from the periphery of the substrate to the terminal portion of the optical guide,
wherein each terminal portion is configured to direct light, in use, from the optical guide outwardly from the transparent substrate towards a viewer, and
wherein the terminal portions are arranged to form a segmented display, such that selective illumination of the terminal portions in combination displays information to the viewer.

14. Eyewear as claimed in claim 13, further comprising a lens arranged to produce a focussed image of the segmented display for the viewer, in use.

15. Eyewear as claimed in claim 14, wherein the image is focussed substantially at infinity.

16. Eyewear as claimed in claim 13, wherein the optical guides are located within the transparent substrate.

17. Eyewear as claimed in claim 16, wherein the transparent substrate comprises at least two layers between which the optical guides are located.

18. Eyewear as claimed in claim 13, wherein the terminal portion of each optical guide comprises a reflecting surface at an acute angle to the direction of light transmission within the optical guide, the surface being arranged to reflect the light from the optical guide towards the viewer.

19. Eyewear as claimed in claim 18, wherein the terminal portion of each optical guide comprises a plurality of the reflecting surfaces.

20. Eyewear as claimed in claim 19, wherein the terminal portion of at least some of the optical guides forks into a plurality of light paths, each having a respective reflecting surface.

21. Eyewear as claimed in claim 19, wherein the terminal portion of at least some of the optical guides has a stepped profiled, with each step having a respective reflective surface.

22. Eyewear as claimed in claim 13, further comprising a respective light source for each optical guide mounted to the periphery of the transparent substrate.
